(19) United States
(12) Patent Application Publication
(10) Pub. No.: US 2012/0274328 A1
(43) Pub. Date: Nov. 1, 2012

(54) AXIAL HIGH VOLTAGE TRANSFORMER WITH SIGNAL PASS-THROUGH ABILITY

(76) Inventors: Gary J. Hanington, Elko, NV (US); Joseph Hanington, Elko, NV (US); Peter Hanington, Elko, NV (US)

(21) Appl. No.: 13/460,666

(22) Filed: Apr. 30, 2012

Related U.S. Application Data
(60) Provisional application No. 61/480,164, filed on Apr. 28, 2011.

(51) Int. Cl. G01V 3/18; H01F 27/36

(52) U.S. Cl. 324/324; 336/84 M

(57) ABSTRACT

A high voltage power supply particularly for use in small diameter spaces such as in oil well logging devices. An axial linear high voltage step-up transformer has an integral through hole in the internal ferrite, low voltage sensing signals may be passed through from the output section of the power supply. In addition, a magnetic field shield is designed into the device to prevent eddy currents from forming in the metallic pressure vessel housing which is used to contain the neutron generating tube which is under pressure of an insulating gas such as sulfur hexafluoride. By constructing an axial transformer, and passing the signal leads through the internal hole, the largest amount of internal dielectric may be utilized, increasing the reliability of the transformer. By containing the magnetic field and limiting the eddy currents induced in outside metals, the converter efficiency may be raised to the maximum possible.

### CITATION OF RELATED ART

This application claims the benefit of, and priority to, U.S. Provisional Patent Application 61/480,164 filed on Apr. 28, 2011, the contents of which are hereby incorporated by reference herein.

### BACKGROUND OF THE INVENTION

1. Field of the Invention

The present invention relates generally to power supplies for generating high voltages. More particularly, the present invention relates to a high voltage power supply such as used with neutron generating tubes in oil well logging equipment. Further, the invention relates to the high voltage step up transformer required in such power supplies.

2. Related Art

Oil well logging devices which include neutron generating tubes are well known in the art. Such devices are sized to be lowered down an oil well bore and emit neutrons into the formation through which the bore passes. By detecting the radiation coming back from the formation, particularly the atoms in the formation that have been made radioactive by the emitted neutrons, the location of the oil bearing strata can be determined along the depth of the well. This return radiation indicates where the well casing should be perforated to allow oil to flow into the well.

The neutron generating tubes, which are the heart of these logging devices, require 100,000 volts, or more, to operate. Currently available logging devices generally use a Cockroft-Walton type voltage multiplier circuit which includes capacitors and rectifiers, which take an AC voltage from a high voltage step up transformer and converts it to a high DC voltage by successively raising up the voltage in a step wise fashion to operate the neutron generating tube. Voltage multiplying circuits using capacitors and rectifiers are well known, with the Cockroft-Walton series multiplier type circuit being commonly used in the currently available logging devices. To generate the required DC voltage needed by the neutron tube, the AC output voltage of the step-up transformer depends upon the number of stages utilized in the voltage multiplier, with 10 kV peak to peak being an average value among commonly available logging tools. To generate this high AC voltage within a working diameter of 1.25 inches (3.18 cm) is no easy task, especially with the fact that coaxial signal sensing conductors from the voltage multiplier must be run past the high voltage transformer assembly. This allows little room for dielectric insulation between the high voltage secondary windings and the magnetic core structure of the transformer, usually a ferrite material (which is conductive to high voltage). To further complicate the situation, these logging tools must be run at high underground temperatures, sometimes inside of a high-pressure housing. Many of the deep oil wells currently being drilled have internal temperatures in the deeper parts of the well over 150 degrees C. and up to 175 degrees C. or greater. This presents a problem in logging the deeper portions of the wells because, as indicated, the high voltage transformer must step up the incoming voltage with a limited amount of cross sectional area allotment, consequently this component is usually the least reliable of all devices in the 100 kV power supply. Therefore the presently used logging devices do not operate satisfactorily at extreme temperatures. Another problem often encountered is the operation of the ferrite transformer inside of a metal enclosure. If the ferrite is composed of two parts, such as in a high voltage C core configuration, the gap at the interface may leak magnetic flux into the pipe structure, causing excessive eddy currents which increase the loss of the power converter.

To offset this situation, some manufacturers decrease the high voltage output from the step up transformer and compensate by increasing the number of stages of the voltage multiplier circuitry. Unfortunately, there is a reasonable limit on the number of multiplying stages that can be used in a Cockroft-Walton series voltage multiplying circuit. Several reasons exist for this limit. One deals with the output voltage droop that occurs between no load and full load conditions which is proportional to the cube of the number of stages utilized. When the neutron tube is gated to be on, it is not uncommon to find the 100 kV dropping towards 80 kV as the power supply tries to feed into the load of the tube. A second problem that occurs when the number of stages is increased is the increase of AC ripple voltage that rides on the high voltage DC output due to the incomplete conversion of alternating to direct voltage. This unwanted electrical noise interferes with the acceleration voltage of the tube and is difficult to remove from the process. Unfortunately, the ripple voltage present on the high voltage output is proportional to the square of the number of stages used in the multiplier. It would be better if a reliable high voltage transformer can be devised which can be operated in excess of 10,000 VAC peak to peak at frequencies above 20 kHz.

As oil wells go deeper in their attempt to locate new sources of petroleum, the need will increase for neutron generating oil well logging equipment that are capable of operating at even higher temperatures, such as temperatures above 175 degrees C.

### SUMMARY OF THE INVENTION

A high voltage step-up transformer includes an internal cylindrical core with internal through hole. The high voltage step-up transformer further includes a linear primary winding. The high voltage step-up transformer further includes a linear scaled bobbin onto which a high voltage secondary winding has been wound. The high voltage step-up transformer further includes a gap integrated into the transformer design between the internal cylindrical core and the outer magnetic field shield. The high voltage step-up transformer further includes a cylindrical outer magnetic field shield.

The internal cylindrical core can be a magnetic ferrite core with the internal through hole sized for passing signal wires there through. The internal cylindrical core can includes a magnetic metal-glass alloy core with internal through hole sized for passing signal wires there through. The linear primary winding can include a layer wound with turns side by side. The high voltage secondary winding can be wound in notches provided in the linear scaled bobbin to separate the individual sections. The cylindrical outer magnetic field shield can include a ferrite material. The cylindrical outer magnetic field shield can include a metal-glass alloy magnetic material. The cylindrical outer magnetic field shield can include a magnetic material. The cylindrical outer magnetic field shield can includes Permalloy. The internal cylindrical core can be positioned to allow signal pass through wires through the internal through hole.

The length of the cylindrical outer magnetic field shield can be at least 1.1 times as long as the length of the inner cylindrical core. The internal cylindrical magnetic material core with signal wire pass-through hole can include a powdered iron alloy material. The linear primary winding can include a one-layer primary winding of turns wound side by side and is constructed with a high temperature insulation wire. The linear scaled bobbin onto which the secondary has been wound can be constructed of a material with melting point above 125 degrees Celsius.

The bobbin diameter can be tapered to increase the dielectric spacing between the outer secondary wires and the magnetic shield.

The cylindrical outer magnetic field shield can be at least 1.1 times as long as the inner cylindrical core and can be composed of a ferrite material. The cylindrical outer magnetic field can be composed of a metal-glass alloy material. The cylindrical outer magnetic field shield can be composed of a nickel-iron alloy material.

### BRIEF DESCRIPTION OF THE DRAWINGS

FIG. 1 illustrates a high voltage C core transformer;

FIG. 2 shows a cross-sectional view of a C core high voltage transformer in a high voltage power supply;

FIG. 3 illustrates a pot core type transformer;

FIG. 4 illustrates an axial high voltage transformer with signal pass-through ability;

FIG. 5A is a general diagrammatic block diagram of an oil well logging device as currently used to log oil wells, and with which the high voltage power supply of the present invention may be used;

FIG. 5B is a vertical section through an oil well logging device as currently used again showing a general diagrammatic view of the logging device of FIG. 1 and showing a four stage Cockroft-Walton high voltage multiplier circuit; and

FIGS. 6A and 6B illustrate a tapered bobbin to increase dielectric insulation distance between the secondary winding and the inner magnetic material.

### DETAILED DESCRIPTION OF THE ILLUSTRATED EMBODIMENTS

As disclosed herein, ferrite cores are ideal for miniature step up high voltage transformers. Ferrite cores can be fabricated into practical shapes far more easily than silicon iron laminations, and in turn allow for less eddy current loss. Consequently, ferrite cores can be operated at much higher conversion frequency than iron lamination types, with a typical frequency in excess of 20 kHz. Most iron lamination high voltage transformers must be operated below 10 kHz—due to excessive eddy current and hysteresis losses. Operation at higher frequencies allows less droop in output voltage with less output ripple as well. Power supply designers who utilize ferrites in their high voltage transformer design can decrease the value of the multiplier capacitors used in the voltage multiplying section. It is therefore desirous to design neutron generating high voltage power supplies with ferrite material and take advantage of the improvement in volumetric efficiency as a result of higher frequency operation.

Using ferrites also increases the overall reliability of the converter because smaller value high voltage capacitors are inherently less likely to fail due to the decrease in plate area. While it is true that silicon iron lamination transformers enjoy a higher B field saturation flux density than ferrite devices by a factor of over three times, this is more than offset by the fact that they must be operated at lower frequencies as mentioned above. The only benefit that silicon iron transformers seem to have is their extremely high Curie point—the temperature where the relative permeability of the core material drops quickly towards zero. Values above 1000 degrees Celsius are quite common, which is certainly an advantage for high temperature power supply operation. The Curie point of manganese, or zinc ferrites, on the other hand are comparatively low, with values typically in the vicinity of 230 degrees Celsius. With careful design this handicap can be overcome by lowering the operational B field by increasing the number of turns placed on the transformer. Operation at values of one half the maximum saturation flux density (e.g. at 175 degrees C.) seem to be acceptable with respect to converter efficiency. This usually requires increasing both the primary and secondary turns of the transformer to higher values than one would normally use for room temperature designs.

1. Examples of Previous High Voltage Transformers and Problems Discovered by the Inventor Associated Thereto

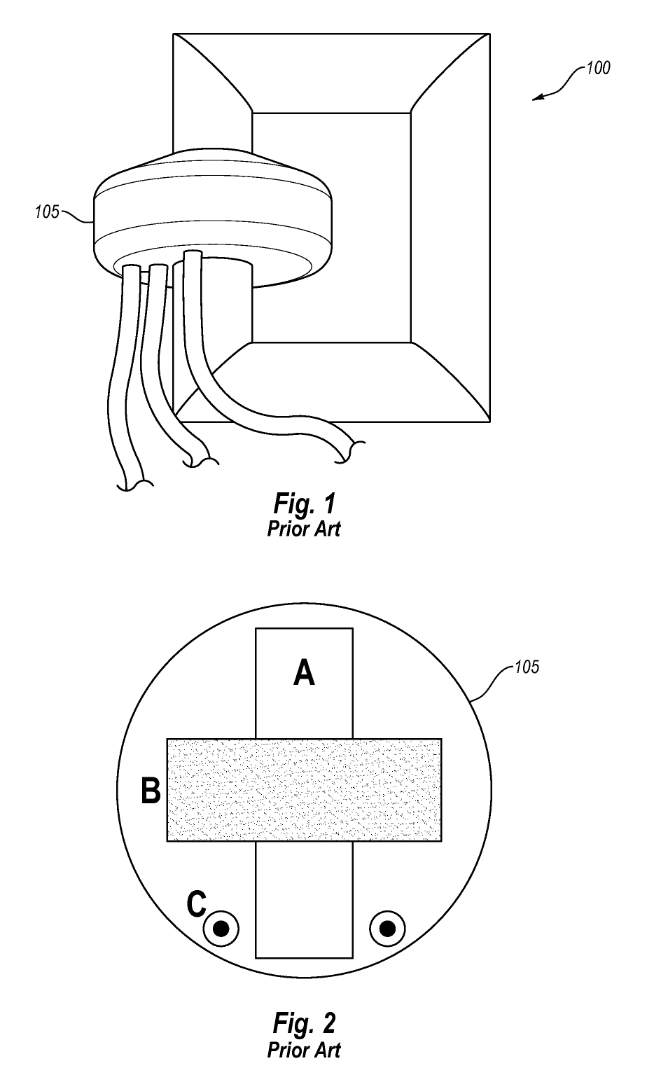

As shown in FIG. 1, one of the most favored core arrangement of the high voltage transformer is the C core design 100. The C core design 100 allows for less capacitance seen at the transformer secondary winding—increasing operational frequency and less problems due to arcing to the ferrite core itself.

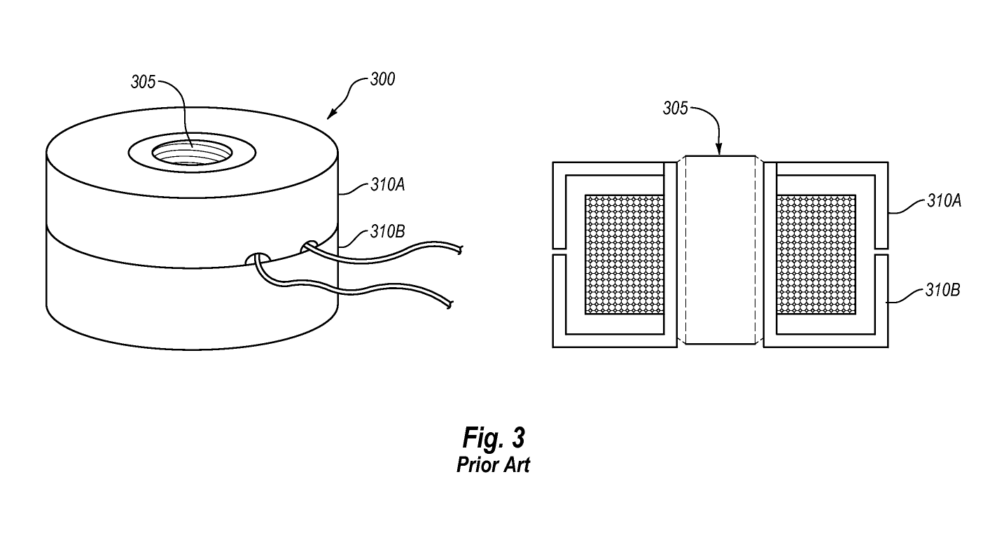

FIG. 2 shows a cross-sectional view of a C core high voltage transformer in a high voltage (HV) power supply. In FIG. 2, the placement of this type of transformer within the circular structure of the housing 105 is shown, where A=core, B=winding, C=signal wires from high voltage (HV) multiplier.

In well logging tools it is important to keep all of the magnetic flux within the core of the transformer design and not allow the magnetic flux to extend beyond the perimeter of the converter housing 105. If this happens, large eddy currents may be set up within the stainless steel pressure containment vessel that these devices are usually sealed in. If the AC magnetic field extends to the pressure vessel pipe, increases in input current to the converter will be noted causing more heat within the already hot device. The C, or even E, core designs suffer from this problem because the device is composed of two parts placed together with a gap between the mating halves. This gap is required to prevent saturation of the ferrites as a result of waveform imbalance. A gap is also required to increase the operating frequency of the device beyond 20 kHz.

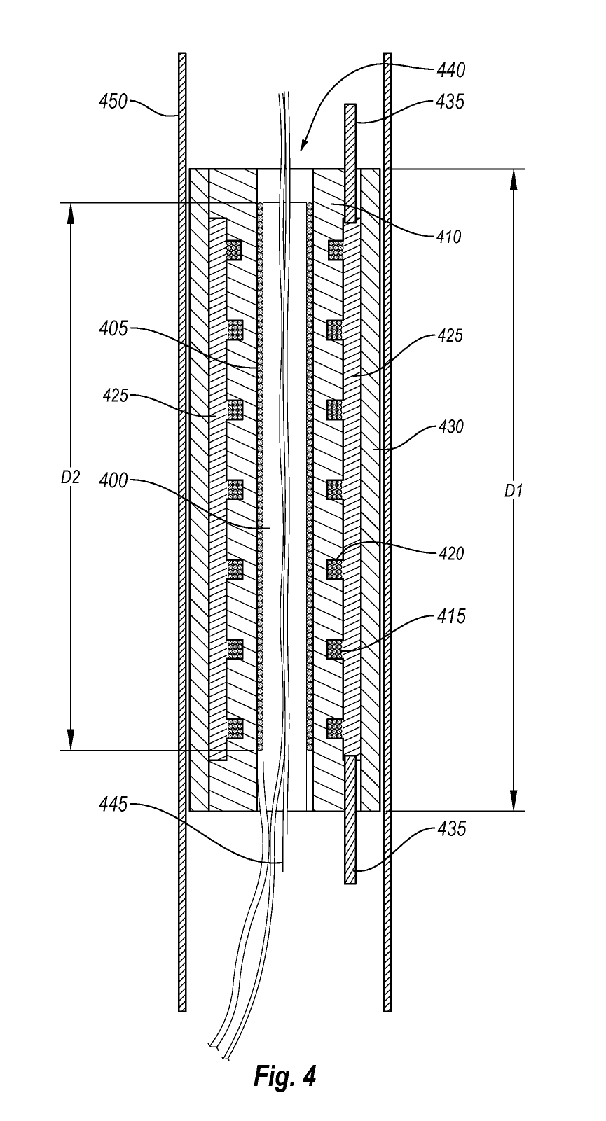

One solution to this problem is to utilize a pot core type transformer 300 as shown in FIG. 3. Unfortunately, pot core transformers 300 do not lend themselves to high voltage transformer fabrication. The reason for this statement can be seen in the inherent construction of such device 300. The high voltage windings are enclosed within the structure which, due to limited length, must build up the voltage within a limited distance within the core 300 itself. Since the central internal hole 305 of the device is used to fasten both halves 310A and 310B together, an otherwise ideal location for signal pass through from the multiplier voltage sensing divider cannot be utilized, consequently these wires (usually current and voltage feedback wires) must be run on the outside of the pot core 300, limiting one to the maximum size that can be utilized so as to retain space to run these signal wires externally around the outside of the pot core. For a pressure vessel housing of 1.25 inches diameter, for example, the largest pot core that can be utilized is the standard 2616 type, which has, through practical application, a maximum high voltage output of 6,000 Volts peak to peak. Any attempts to generate high output voltages within this pot core will seriously reduce the reliability of the device.

2. Axial High Voltage Transformer with Signal Pass-Through Ability

The present invention includes a high voltage step up transformer offering a very high self-resonant frequency that is highly, or preferably completely, self-shielding in the radial direction. The high voltage step-up transformer can be used in any situation where a high voltage is needed. A specific application of the high voltage step-up transformer of the invention is in connection with oil well logging devices which are lowered down an oil well while emitting pulses of neutrons into the formation through which the well extends to find the oil bearing strata intersected by the well. The high voltage step up transformer is constructed with the axial mechanical constraints present in narrow bore down-hole applications in mind as highly advantageous applications, while other applications may also be applicable and highly advantageous as well. By suitable adjustment of primary and secondary winding ratio, the high voltage step up transformer can be utilized with any oscillatory input voltage to achieve the required step-up ratio. This transformer operates at a very high resonant frequency (e.g. f>80 kHz) due to its large magnetic field gap which is self-contained within the structure of the design itself. By utilizing a shielding outer ferrite core, the magnetic field is contained and will not reach out to the pressure vessel in which the power supply is mounted. Moreover, the design of this invention allows for easy signal wire pass through in the center of the device where the magnetic field is zero due to the inner ferrite core. Without having to run the signal wires from the output high voltage multiplier back along the outside of the transformer, the largest ferrite may extend to the inner diameter of the pressure vessel may be used. This increases both the electrical efficiency and the reliability of the step-up transformer which is important for high temperature operation as mentioned earlier.

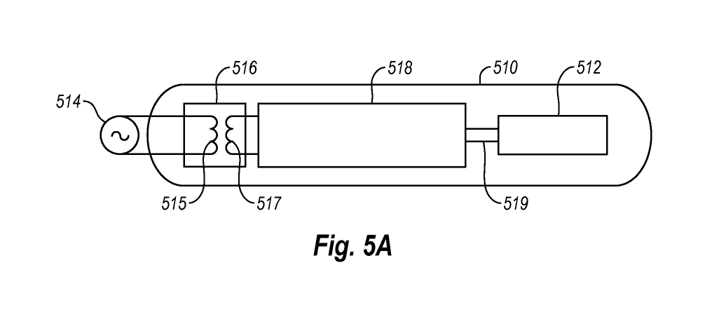

An example embodiment described herein is shown in FIG. 4 where the transformer includes an inner ferrite core 400 around which a primary winding 405 is wound in lengthwise fashion. This assembly is inserted into a specially machined bobbin 410 on which a secondary winding 415 is wound. Recesses 420 within the bobbin 410 are utilized to act as multiple bobbins and the secondary winding 415 is broken up into many sections within these recesses 420, each providing a fraction of the high voltage output when summed together. Beyond the secondary 415 is a region that has been encapsulated with a high temperature epoxy resin 425, capable of preventing arcing between the high voltage winding of the secondary 415 and an outer ferrite shield 430. Beyond this encapsulated region is the outer ferrite shield 430 run D1 at a minimum of 1.10 times the length D2 of the inner ferrite 400 upon which the primary 405 is wound. By extending the length Dl of the outer ferrite shield 430 beyond the length D2 of the inner core 400, entrapment of the magnetic field is maximized, if not assured. The start and finish of the secondary windings 415 are made using insulating pins 435, which can be molded into the bobbin 410 itself.

Having a hole 440 in the central inner core 400 allows signal wires 445 from the high voltage multiplier section of the tool to be routed through and down to the control section of a power supply without the need to run the signal sires 445 about the outside of the outer ferrite shield 430. As such, the outer diameter of the outer ferrite shield can be increased such that to the entire inner diameter of the logging device's outer housing wall 450. For example, this inner diameter might be about 1.25 inches (3.18 cm), or less.

The internal cylindrical core 400 can be made from a magnetic metal-glass alloy core with internal through hole sized for passing signal wires there through. The linear primary winding 405 can be layer wound with turns side by side as shown. The high voltage secondary winding 415 can be wound in notches provided in the linear scaled bobbin 410 to separate the individual sections. The cylindrical outer magnetic field shield 430 can includes a ferrite material. The cylindrical outer magnetic field shield 430 can be composed of a metal-glass alloy magnetic material. The cylindrical outer magnetic field shield includes a magnetic material, such as Permalloy. The internal cylindrical magnetic material core with signal wire pass-through hole can include a powdered iron alloy material. And, the linear primary winding can include a one-layer primary winding of turns wound side by side and be constructed with a high temperature insulation wire. The linear scaled bobbin 410 onto which the secondary 415 has been wound can be constructed of a material with melting point above 125 degrees Celsius. The cylindrical outer magnetic field shield can be composed of a nickel-iron alloy material, for example.

3. Examples of Oil Logging Devices Within Which the Axial High Voltage Transformer with Signal Pass-Through Ability May be Used

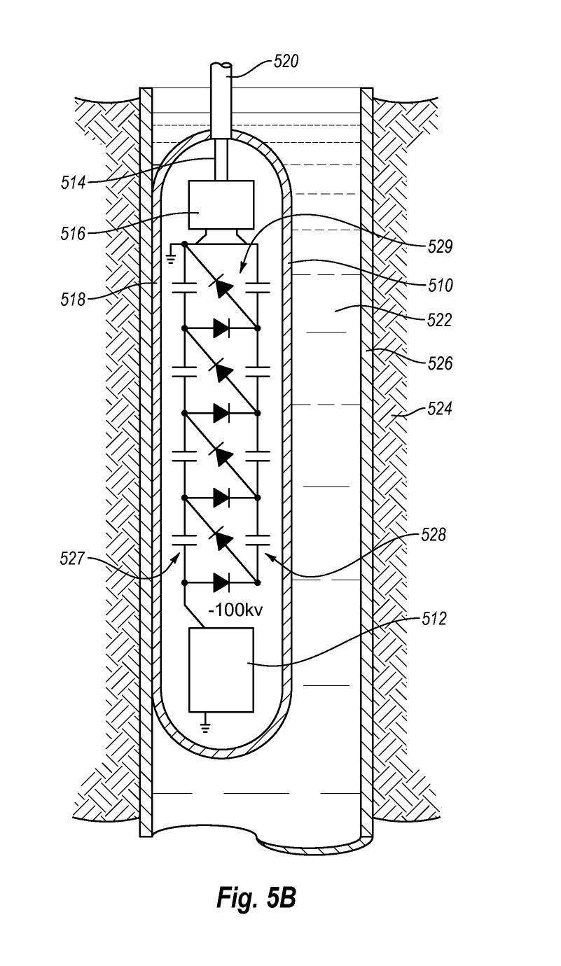

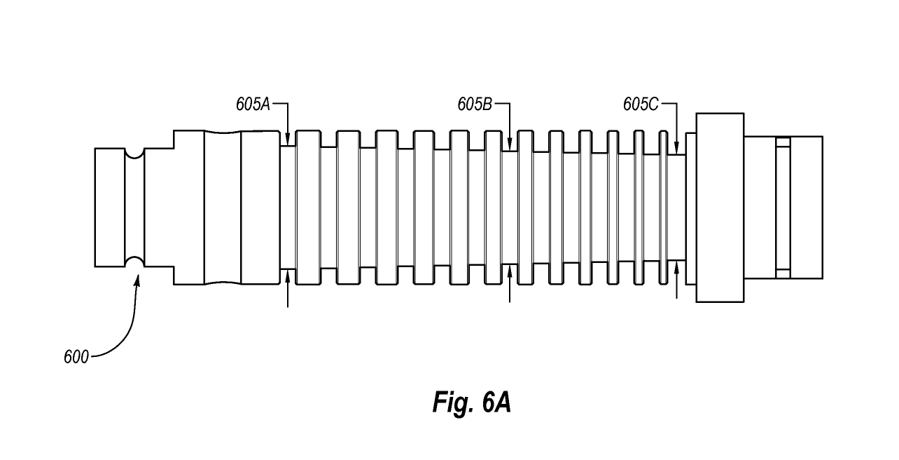

Referring to FIGS. 5A and 5B, an oil well logging device will generally include a metal case 510 which houses a neutron source 512 in the form of a neutron generating acceleration tube. Such a tube requires a voltage of around 100,000 volts (100 kV) to accelerate charged particles from a particle source to impact a target material which releases neutrons when hit with the accelerated particles. Such neutron sources are well known in the art and are commonly used in oil well logging devices. The required high voltage for the neutron source is supplied by a high voltage DC power supply which usually includes an AC power source connected to a voltage multiplier circuit. In the illustrated embodiment of FIGS. 5A and 5B, the AC voltage source is made up of an AC power supply 514 connected to a step up transformer 516, such as the axial high voltage transformer with signal pass-through ability as discussed in association with FIG. 4 above. As shown, the AC power supply is connected to the primary winding 515 of the step up transformer 516, and the secondary winding 517 of the step up transformer 516, which provides the AC output voltage signal of the AC power source 514, is connected to the input of the voltage multiplier circuit 518. The voltage multiplier circuit 518 takes the AC output voltage signal from the AC power source, i.e. from secondary winding 517 of the step up transformer 516, and converts it to the high voltage DC output 519 by successively raising the voltage in a step wise fashion. The usual voltage multiplier circuit 518 used in such currently available oil well logging devices is the Cockroft-Walton series multiplier circuit as shown in FIG. 5B, while other voltage multiplier circuits can be used. The high voltage DC output 519 of the voltage multiplier circuit 518 is connected in usual manner to the neutron source 512.

As indicated, the logging devices as shown in FIG. 5B generally include a cylindrical housing 510 which is suspended in an oil well 522 by a cable 520 which can be extended from the top of the well to lower the logging device down the well or can be pulled up to raise the logging device in the well. The well extends through a ground formation 524 and may be cased with casing pipe 526. Because the casing of the well is generally about two inches in inside diameter, the logging device housing has an outside diameter of less than two inches so that it can fit into and move up and down the well. This means that the inside diameter of the housing 510 for the device is between about one and one quarter and two inches which can correspond to the outer diameter of the axial high voltage transformer with signal pass-through ability as discussed above. Everything in the housing 518 as described has to fit within this small diameter. However with the inventive pass-through transformer as disclosed and described herein, the diameter of the transformer housing can be maximized.

As shown in FIG. 5B, the AC power supply 514 may be a wire extending down the cable 520 suspending the logging device from the top of the well. An AC signal from the top of the well is then sent down the wire to the logging device. Alternately, the AC power source can be located in the logging device itself, and, for example, include a battery and an inverter to generate the AC input signal to the primary winding 515 of the step up transformer 516. A new drilling technique referred to as MWD (measure while drilling) uses well drilling equipment which incorporates a well logging device with neutron generating tube in the drilling equipment. This means that the well is logged as it is drilled and there is no separate logging device as shown in FIG. 5B that is lowered by a cable into the well after the well is drilled. With this new drilling equipment, the various components described are incorporated into the drilling equipment and operate in the same manner as described for the separate logging device to perform the logging as the well is being drilled. With this new equipment, the AC power supply 514 may be a local generator which generates AC or DC power as the drill rotates in the well.

FIG. 5B includes a circuit diagram for the traditional Cockroft-Walton series voltage multiplier circuit as the voltage multiplier circuit of block 518. As shown in FIG. 5B, a four stage Cockroft-Walton series multiplier circuit includes a set of capacitors 527 connected in series with the grounded output of the step up transformer 516 and a set of capacitors 528 connected in series with the ungrounded output of the step up transformer 16. The individual capacitors of the two sets 527 and 528 of capacitors are connected by a rectifier matrix made up of rectifiers 529. Each set of capacitors are shown with four individual capacitors connected in series with a corresponding capacitor of each series connected by two opposing polarity rectifiers to form one of the four multiplication stages. Thus, the Cockroft-Walton series multiplier circuit includes two sets of capacitors, each of which have the capacitors of the set connected in series.

In the embodiments shown, the invention is directed to the high voltage transformer with signal wire pass-through ability. The other parts of the high voltage supply and the oil well logging device in which the high voltage supply and the voltage multiplier circuit of the invention is shown, as an example of its use as shown in FIGS. 5A and 5B.

4. Tapered Bobbin for the Axial High Voltage Transformer with Signal Pass-Through Ability

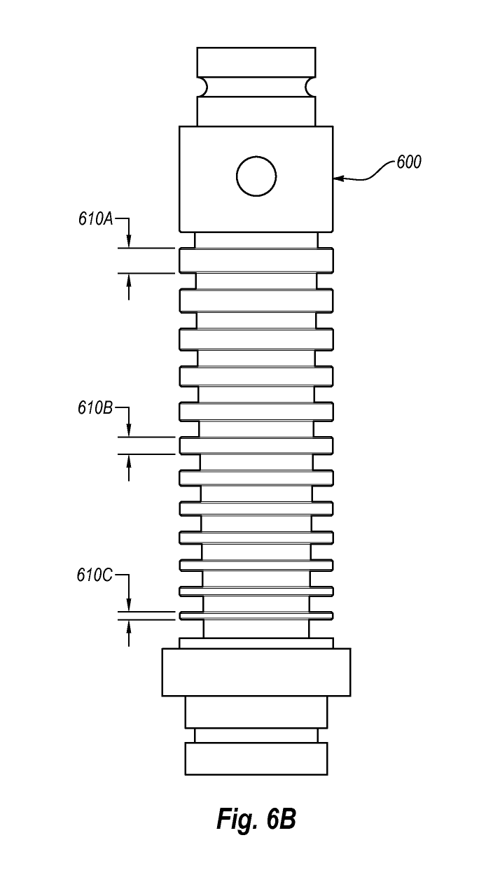

FIGS. 6A and 6B illustrate a tapered bobbin to increase dielectric insulation distance between certain windings of the secondary winding and the inner magnetic material. The linear scaled bobbin can be tapered to increase dielectric insulation distance between certain windings and the high voltage secondary winding secondary winding and the external magnetic shield. The linear scaled bobbin can also be tapered to increase the distance between certain windings themselves. The tapering can be gradual, abrupt, or according to a predetermined scheme.

As shown in FIG. 6A, the outer diameter of the surface of which the secondary winding is wound can gradually, or abruptly, increase or decrease along the length of the linear scaled bobbin 600. For example, a first outer diameter of a first winding surface 605A can be greater than a second outer diameter of a second winding surface 605B, which can both have a greater outer diameter of a third winding surface 605C. Thus, the distance between the secondary winding wound about the first winding surface 605A and an internal cylindrical core (see FIG. 4) is greater than the distance between the secondary windings wound about the second and third winding surfaces 605A and 605B and the internal cylindrical core. Similarly, the distance between the secondary winding wound about the first winding surface 605A and a cylindrical outer magnetic field shield (see FIG. 4) is less than the distance between the secondary windings wound about the second and third winding surfaces 605A and the cylindrical outer magnetic field shield.

For example, in one working model the diameter of the first winding surface 605A can be 0.78 inches thick, the diameter of the second winding surface 605B can be 0.716 inches thick, and the diameter of the third winding surface 605C can be 0.668 inches thick. And, the diameters of the winding surfaces there between can gradually decrease accordingly.

Further, the distance between the winding surfaces can gradually increase or decrease along the length of the tapered bobbin. For example, referring to FIG. 6B the tapered linear scaled bobbin 600 is illustrated where a first distance 610A is greater than a second distance 610B, which is in-turn greater than a third distance 610C. This distance can correspond to a thickness of material between a first winding surface and its adjacent winding surface.

For example, in the one working model previously discussed the first distance 610A can be 0.160 inches, the second distance can be 0.110 inches and the third distance can be 0.050 inches. And, the distances can gradually decrease across the length there between accordingly.

1. A high voltage step-up transformer comprising:
an internal cylindrical core with internal through hole;
a linear primary winding;
a linear scaled bobbin onto which a high voltage secondary winding has been wound;
a gap integrated into the transformer design between the internal cylindrical core and the outer magnetic field shield; and
a cylindrical outer magnetic field shield.

2. A high voltage step-up transformer according to claim 1, wherein the internal cylindrical core is a magnetic ferrite core with the internal through hole sized for passing signal wires there through.

3. A high voltage step-up transformer according to claim 1, wherein the internal cylindrical core includes a magnetic metal-glass alloy core with internal through hole sized for passing signal wires there through.

4. A high voltage step-up transformer according to claim 1, wherein the linear primary winding includes a layer wound with turns side by side.

5. A high voltage step-up transformer according to claim 1, wherein the high voltage secondary winding is wound in notches provided in the linear scaled bobbin to separate the individual sections.

6. A high voltage step-up transformer according to claim 1, wherein the cylindrical outer magnetic field shield includes a ferrite material.

7. A high voltage step-up transformer according to claim 1, wherein the cylindrical outer magnetic field shield includes a metal-glass alloy magnetic material.

8. A high voltage step-up transformer according to claim 1, wherein the cylindrical outer magnetic field shield includes a magnetic material.

9. A high voltage step-up transformer according to claim 1, wherein the cylindrical outer magnetic field shield includes Permalloy.

10. A high voltage step-up transformer according to claim 1, wherein the internal cylindrical core is positioned to allow signal pass through wires through the internal through hole.

11. A high voltage step-up transformer according to claim 1, wherein the length of the cylindrical outer magnetic field shield is at least 1.1 times as long as the length of the inner cylindrical core.

12. A high voltage step-up transformer according to claim 1, wherein the internal cylindrical magnetic material core with signal wire pass-through hole includes a powdered iron alloy material.

13. A high voltage step-up transformer according to claim 1, wherein the linear primary winding includes a one-layer primary winding of turns wound side by side and is constructed with a high temperature insulation wire.

14. A high voltage step-up transformer according to claim 1, wherein the linear scaled bobbin onto which the secondary has been wound is constructed of a material with melting point above 125 degrees Celsius.

15. A high voltage step-up transformer according to claim 1 wherein the cylindrical outer magnetic field shield at least 1.1 times as long as the inner cylindrical core and is composed of a ferrite material.

16. A high voltage step-up transformer according to claim 1, wherein the cylindrical outer magnetic field shield is at least 1.1 times as long as the inner cylindrical core and is composed of a metal-glass alloy material.

17. A high voltage step-up transformer according to claim 1, wherein the cylindrical outer magnetic field shield at least 1.1 times as long as the inner cylindrical core is composed of a nickel-iron alloy material.

18. A high voltage step-up transformer according to claim 1, wherein the linear scaled bobbin is tapered to increase dielectric insulation distance between the high voltage secondary winding and the an internal cylindrical core along the length of the linear scaled bobbin.

19. A high voltage step-up transformer according to claim 1, wherein the linear scaled bobbin is tapered to increase dielectric insulation distance between the high voltage secondary winding and the cylindrical outer magnetic field shield along the length of the linear scaled bobbin.

20. A high voltage step-up transformer according to claim 1, wherein the linear scaled bobbin is tapered such that the distances between windings of the high voltage secondary winding decrease along the length of the linear scaled bobbin.

21. An oil well logging device comprising:
a neutron source in the form of a neutron generating acceleration tube;
a voltage multiplier circuit;
a high voltage step-up transformer with signal pass-through capability according to claim 1; and
a metal case housing the neutron source, voltage multiplier circuit, and high voltage step-up transformer.

22. A high voltage step-up transformer comprising:
an internal core with internal through hole for signal wires to be run therein;
a linear primary winding;
a linear scaled bobbin onto which a high voltage secondary winding has been wound;
a gap integrated into the transformer design between the internal cylindrical core and the outer magnetic field shield; and
a cylindrical outer magnetic field shield, wherein an outer diameter of the cylindrical outer magnetic field shield corresponds to an inner diameter of a metal case of an oil well logging device within which the high voltage step-up transformer is to disposed.

23. An oil well logging device comprising:
a neutron source in the form of a neutron generating acceleration tube;
a voltage multiplier circuit;
a high voltage step-up transformer with signal pass-through capability according to claim 22; and
the metal case housing the neutron source, voltage multiplier circuit, and high voltage step-up transformer.
